(19) United States
(12) Patent Application Publication
(10) Pub. No.: US 2015/0134312 A1
(43) Pub. Date: May 14, 2015

(54) Evaluation of Service Delivery Models

(71) Applicant: International Business Machines Corporation, Armonk, NY (US)

(72) Inventors: Gargi B. Dasgupta, Bangalore (IN); Shivali Agarwal, Bangalore (IN); Renuka R. Sindhgatta, Bangalore (IN); Nirmit V. Desai, Bangalore (IN)

(73) Assignee: International Business Machines Corporation, Armonk, NY (US)

(21) Appl. No.: 14/076,858

(22) Filed: Nov. 11, 2013

(51) Int. Cl. G06F 17/50

(52) U.S. Cl. CPC G06F 17/5009
USPC 703/6

(57) ABSTRACT

Methods, systems, and articles of manufacture for evaluation of service delivery models are provided herein. A method includes evaluating a set of multiple service delivery models against one or more metrics; selecting one service delivery model from the set of multiple service delivery models based on said evaluating; activating said selected service delivery model within a system; and re-evaluating said selected service delivery model based on data collected subsequent to said activating.

### FIELD OF THE INVENTION

Embodiments of the invention generally relate to information technology (IT), and, more particularly, to service delivery models.

### BACKGROUND

Enterprises and IT service providers are increasingly challenged with the objective of improving quality of service while reducing the cost of delivery. For example, effective distribution of complex customer workloads among delivery teams served by diverse personnel under service agreements presents various management challenges. As a result of such challenges, delivery model organizations can differ, for example, in terms of how personnel teams are formed for solving customer service requests, how skills of personnel are used for solving the requests, how work queues and flows through personnel teams for solving a request, etc.

A single model of delivery for all clients is sub-optimal, while a fixed definition of personnel teams is also not sustainable or advantageous. Accordingly, a need exists for generating a model of delivery that forms teams based on need, in accordance with parameters such as, for example, availability and skills of personnel, and required performance attributes.

### SUMMARY

In one aspect of the present invention, techniques for evaluation of service delivery models are provided. An exemplary computer-implemented method can include steps of evaluating a set of multiple service delivery models against one or more metrics; selecting one service delivery model from the set of multiple service delivery models based on said evaluating; activating said selected service delivery model within a system; and re-evaluating said selected service delivery model based on data collected subsequent to said activating.

In another aspect of the invention, an exemplary computer-implemented method can include steps of evaluating a set of multiple service delivery models against a set of multiple pre-defined metrics; selecting a first service delivery model from the set of multiple service delivery models for implementation based on said evaluating; re-evaluating said first service delivery model at a determined time interval based on data collected pertaining to one or more operational characteristics of the first service delivery model; and changing implementation of the first service delivery model to implementation of a second service delivery model from the set of multiple service delivery models based a change in the one or more operational characteristics of the first service delivery model by a determined amount.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating an example embodiment, according to an aspect of the invention;

FIG. 2 is a flow diagram illustrating techniques according to an embodiment of the invention; and

FIG. 3 is a system diagram of an exemplary computer system on which at least one embodiment of the invention can be implemented.

### DETAILED DESCRIPTION

As described herein, an aspect of the present invention includes simulation-based evaluation of delivery models in service systems. As used herein, a service delivery model is the organization of the service workers, the processes and the resolution workflows defined for meeting customer requirements and expectations. At least one embodiment of the invention includes simulating multiple delivery models within a context of complex customer workloads, stringent service contracts, and evolving skills, with an objective of deriving design principles of delivery organizations. Accordingly, such an embodiment includes instantiation of multiple models of service delivery using a meta-model of service delivery, evaluation of the multiple models, and ranking of the multiple models according to one or more pre-defined metrics such as cost, quality of work, resource utilization, etc.

As used herein, a service delivery meta-model includes parameters such as skill, work type, work, service time, deadline, work assignment, resource, key performance indicator (KPI), etc., as well as relationships therebetween. In at least one embodiment of the invention, a service delivery meta-model is instantiated by selecting values for each defined parameter and appropriately defined workload. For example, a service system (SS) is a particular instantiation of a model of delivery. SS is formally defined as <id, C, W, H, T, P, X, γ, τ, α, π, β, where:

id is the unique identifier of the SS;

C is a set of customers supported by the SS;

W is a set of service workers in SS, and |W| is the staffing level of the SS;

H is a set of shifts that run the operations of the SS;

T is a set of time intervals during which the arrival rate distribution remains unchanged;

P is a set of priority levels;

X is a set of complexity levels;

γ: <Cᵢ, Pⱼ>→>r₁, r₂>, r₁, r₂ε [symbol] is a map from each customer-priority pair to a pair of real numbers representing the percentage and the resolution time target in hours, respectively;

τ: <Pᵢ, Xⱼ>→<r₁, r₂>, r₁, r₂ε [symbol] is a map from each priority-complexity pair to a pair of real numbers representing the mean and standard deviation of the service time distribution, respectively;

α: <Cᵢ, Tⱼ>→ [symbol] is a map from a customer-time interval pair to a real number representing the inter-arrival time in minutes of service requests from Cᵢ during time interval Tⱼ;

π: W→H is a map from a worker to the shift in which she is available for work; and

β: W→X is a map from a worker to the maximum complexity service request that she is skilled to support.

Additionally, in at least one embodiment of the invention, each SS has a pre-defined swing policy, pre-emption policy, breaks policy, on-call policy, and infrastructure down policy. A swing policy can be invoked, for example, wherein a low queue length exists and/or wherein low-skilled work is assigned to a high skilled resource. Also, a pre-emption policy refers to the transitive closure of the tuples. Further, by way of example, a break policy can specify the number of breaks and/or off-times a worker/individual can take in a specified period of time, and an on-call policy can specify, for instance, the availability of one person at all times over the phone when a high-priority work comes in.

As noted herein, an aspect of the invention includes simulation-based evaluation. Namely, in an example embodiment of the invention, every model is evaluated with a similar input set, and one or more operational metrics such as cost, quality and resource utilization are measured. The delivery models are subsequently ranked based on the resulting values of the operational metrics, and the rankings of the delivery models can additionally be displayed on a dashboard according to each of the predefined metrics.

Additionally, at least one embodiment of the invention also includes computing a distance metric between the multiple delivery models, wherein said distance metric quantifies the difficulty of shifting from one delivery model to another delivery model. The distance metric captures the difference in the models in terms of teaming, resources, policies and workflow. Also, the difficulty in adopting a new model while a current model is in place, as noted above, can be expressed in terms of (a) the number of attributes to be changed and/or (b) the investment in terms of money and/or time needed to change the relevant attributes.

One or more embodiments of the invention can also include selection (by a service manager, for example) of a delivery model from the multiple models based on the rankings along each of the above-noted pre-defined operational metrics as well as the above-noted distance metric. For instance, the cost associated with a delivery model may be very high (if, for instance, the model uses highly-experienced service workers), while the adherence to the customer requirements and service levels can also be very high. Hence, the model would provide a very high rating on the customer service levels and a low rating on the code. Such a ranking can be provided for each operational metric that assists the service manager to identify a suitable service delivery model based on the importance of the operational metric in the context of the customers.

Selecting the best and/or most optimal delivery model can be carried out, for example, manually or automatically based on delivery model rankings and on the distance metric. Additionally, such a selection can be conveyed to an automated engine (or to a human) that implements the selected delivery model in creation of personnel teams and assignment of future service requests (SRs).

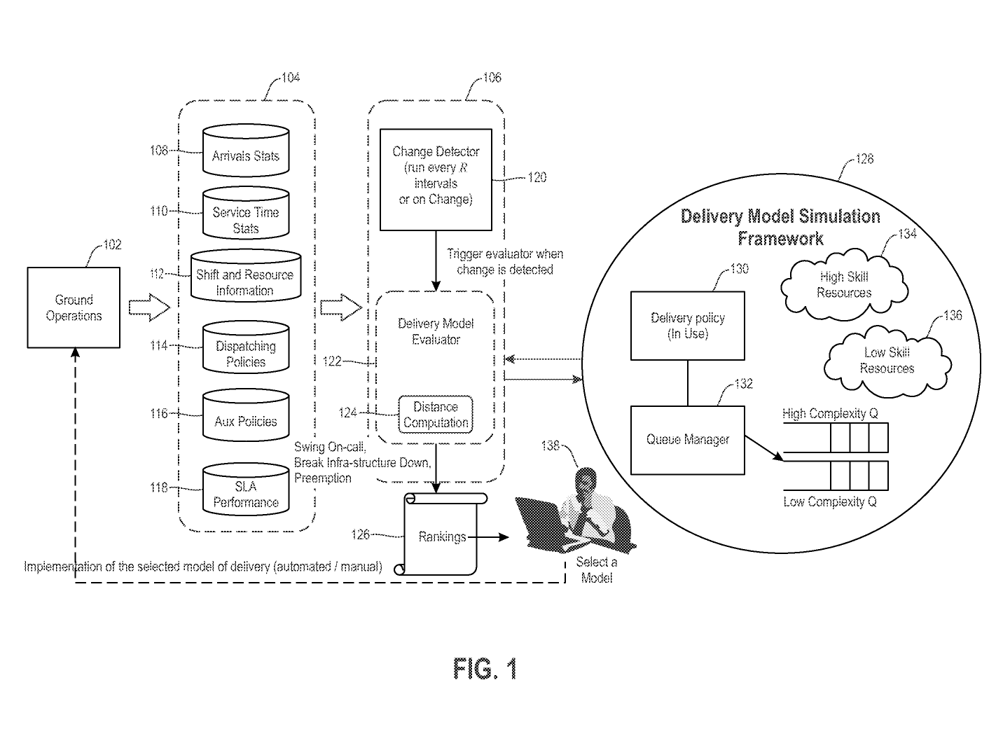

Further, as described herein, at least one embodiment of the invention also includes re-evaluation of multiple delivery models after a pre-determined time period or upon detection of a change in the operational characteristics. By way of example, at a configurable (but preferably regular or consistent) time interval R, SR data are re-submitted to re-compute the arrivals and service time parameters; that is, τ: <Pᵢ, Xⱼ>→<r₁, r₂> and α: <Cᵢ, Tⱼ>→ [symbol] are re-computed based on the most recent data, and a re-evaluation is triggered. Data in such databases (such as depicted in FIG. 1, for example) are continuously added and old or previous data are aged-out (or discarded) using a sliding window mechanism. The window time can be set to a specific time period (for example, a window time of six months would imply that data earlier than six months prior are aged out). The re-evaluation of service delivery is based on the window period that is set. Additionally (and as also further detailed in connection with FIG. 1), a change detector component can detect a change in operational characteristics and trigger re-evaluation.

At least one embodiment of the invention can also include measuring the distance between two delivery models. A value of the distance between two delivery models is a function of <cost, time, reward>. Cost refers specifically to the cost of moving from one delivery model to the second delivery model, and cost is a function of <training costs, hiring costs, costs incurred as a result of restructuring, under-utilization costs>. Time refers to the anticipated time to carry out such a move, and time is a function of <time to train in a required technology/skill, time to hire, time to restructure teams>. Reward refers to the gains of moving from one delivery model to the second delivery model, and reward is a function of <improvement in utilization, improved service level agreements (SLAs), steady state reduction in resource costs>.

By way of a first example, moving from a single skill delivery model to a multi-skill delivery model, when the incoming work is observed to require multiple skills, will incur cost and time, but the rewards will be potentially higher over time. By way of a second example, moving from a dedicated customer delivery model to a shared pool delivery model may benefit utilization while time and cost are primarily consumed in restructuring and management. Additionally, by way of a third example, moving from a single skill sequence dispatch to a single skill collaborative model will be associated with a distance value that is low, while the rewards may be comparatively higher.

In making a determination with respect to the distance between two delivery models, at least one embodiment of the invention includes estimating the cost, time and reward of a prospective movement between the two delivery models, and obtaining pareto optimal pairs of parameters to compute the distance function. Further, one or more embodiments of the invention can subsequently include a manual decision to select the destination model.

FIG. 1 is a block diagram illustrating an example embodiment, according to an aspect of the invention. By way of illustration, FIG. 1 depicts a user 138, one or more ground operations 102, a database component 104, an analysis component 106 and a delivery model simulation framework component 128. Ground operations refer to the real environment of services delivery wherein service workers work on customer-reported tickets that arrive at specific time intervals and require a certain time to get serviced. The service workers work in specific shifts and adhere to certain policies defined in their environment to deliver the work to meet the service levels that have been promised to the customers.

The database component 104, as depicted, can include databases such as an arrival statistics database 108, a service times statistics database 110, a shift and resource information database 112, a dispatching policies database 114, an auxiliary (aux) policies database 116 and an SLA performance database 118. The arrival statistics database 108 can include statistics such as, for example, the arrival rate of work at specific days and hours of the day. The service times statistics database 110 can include statistics such as, for example, the effort spent by the service workers for each completed unit of work. The shift and resource information database 112 can include statistics such as, for example, a shift roster. The dispatching policies database 114 can include policies such as the number of breaks each service worker can take, the policies under which a work item can be transferred to another worker, etc. The SLA performance database 118 can include the SLAs that are committed to the customers.

The delivery model simulation framework component 128 can include, for example, high-skill resources 134 as well as low-skill resources 136. Additionally, the delivery model simulation framework component 128 includes a delivery policy 130 that is in use, and a queue manager component 132. The queue manager component identifies the correct queue to which the work should be delivered. For example, the decision of sending a work item requiring higher skills to a queue of low-skilled workers is determined by the queue manager component based on the delivery policy.

Additionally, the analysis component 106 includes a change detector component 120 (which, as described herein, runs every R intervals or on an observed change in operational characteristics) and a delivery model evaluator component 122, which further includes a distance computation sub-component 124. The delivery model evaluator component 122 evaluates and ranks delivery models based on cost, quality of work and utilization. The delivery model evaluator component 122 also outputs a distance metric, as detailed herein, computed between one or more new delivery models and the current delivery model. The change detector component 120 detects a change in the operational characteristics and determines whether the detected change warrants a re-evaluation of the delivery models. In an instance wherein the change detector component 120 determines that a detected change warrants a re-evaluation of the delivery models, the change detector component 120 triggers an output to the delivery model evaluator component 122 to carry out the re-evaluation.

In at least one embodiment of the invention, data are continuously fed into the delivery model evaluator component 122, which can result in the selection of a different delivery model upon a change of inputs. As detailed herein, the delivery models are evaluated and ranked (by the delivery model evaluator component 122) against one or more pre-defined objectives to produce rankings 126, which can be provided to the user 138.

By way of illustration, such evaluation simulations as described above and in connection with one or more embodiments of the invention can be implemented in example contexts such as the following. For instance, consider a situation wherein the due date dᵢ of a job jᵢ is a scalar, such as in the case of traditional formulations, but is an aggregate in the case of SS. For example, 95% of the service requests by customer X with “urgent” priority must be resolved within four hours of reporting. The 95% is computed over a fixed period of time (for example, over a month) instead of being maintained at all times. Hence, within a month, an allowance is granted such that only 90% of the requests are resolved within four hours in the first week, which is then offset by, for instance, 98% of such requests being resolved in four hours during the rest of the month, achieving the 95% overall. A scheduling formulation with dᵢ=four hours would be over-constrained.

Additionally, consider, for example, a scenario wherein service request queues cannot be analyzed independently of each other because the swing policy may be invoked dynamically, moving service workers to growing queues and changing the rate of service for multiple queues in the system. This disables a large body of existing approaches on queue analysis. Further, consider an example scenario wherein the processing time of a service request is not only stochastic but also has a statistical distribution that varies with the skill level of the service worker to whom it is assigned. Hence, the distribution of the random processing time is unknown at the time of job creation.

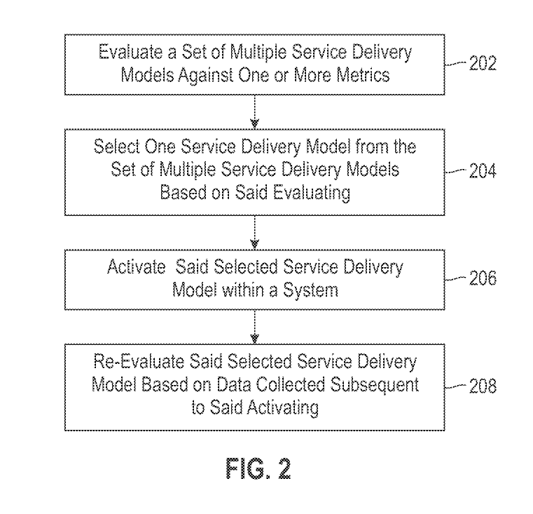

FIG. 2 is a flow diagram illustrating techniques according to an embodiment of the present invention. Step 202 includes evaluating a set of multiple service delivery models against one or more metrics. The metrics can include one or more of cost, quality of work, and utilization using a simulation based on inputs of arrival patterns, service time characteristics, resource skills, contractual service level agreements, shift schedules, and one or more policies. Additionally, each service delivery model can include an instance of a service delivery meta-model including values associated with multiple elements and one or more relationships thereof.

The evaluating step can include evaluating the set of multiple service delivery models against the one or more metrics via service delivery model simulation. Additionally, such simulation can incorporate one or more aggregate SLA constraints, one or more queue management policies, and/or varying service time estimates based on varying skill levels of individuals assigned to a service request.

Step 204 includes selecting one service delivery model from the set of multiple service delivery models based on said evaluating. The selection step can include selecting one service delivery model based on relative importance of the one or more metrics. Step 206 includes activating said selected service delivery model within a system. The activation can be carried out automatically or manually. Step 208 includes re-evaluating said selected service delivery model based on data collected subsequent to said activating.

The techniques depicted in FIG. 2 can also include computing a distance metric that represents a measure of difficulty of shifting between two service delivery models. Additionally, the techniques depicted in FIG. 2 can include ranking said set of multiple service delivery models based on said evaluating. In at least one embodiment of the invention, the step of selecting one service delivery model can include selecting a service delivery model from the set of multiple service delivery models based on said ranking of the multiple service delivery models.

As also detailed herein, at least one embodiment of the invention can include evaluating a set of multiple service delivery models against a set of multiple pre-defined metrics, selecting a first service delivery model from the set of multiple service delivery models for implementation based on said evaluating, and re-evaluating said first service delivery model at a determined time interval based on data collected pertaining to one or more operational characteristics of the first service delivery model. Further, such an embodiment includes changing implementation of the first service delivery model to implementation of a second service delivery model from the set of multiple service delivery models based a change in the one or more operational characteristics of the first service delivery model by a determined amount. In such an embodiment, the operational characteristics can include workload, service time, service level agreement attainment, resource utilization, and/or quality of work. Further, the noted determined amount of change can include a threshold percentage amount from a previous time interval.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and configured to perform exemplary method steps.

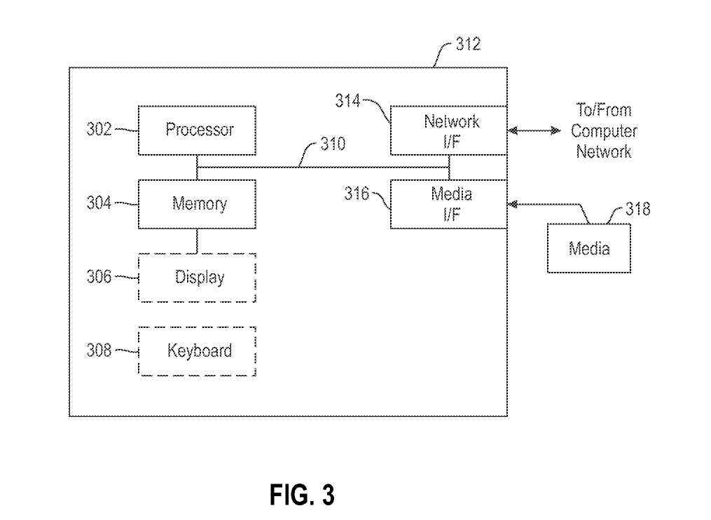

Additionally, an aspect of the present invention can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

As noted, aspects of the present invention may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, radio frequency (RF), etc., or any suitable combination of the foregoing.

Computer program code for carrying out operations for aspects of the present invention may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, instantiation and evaluation of multiple models of service delivery using a meta-model of service delivery.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
evaluating a set of multiple service delivery models against one or more metrics;
selecting one service delivery model from the set of multiple service delivery models based on said evaluating;
activating said selected service delivery model within a system; and
re-evaluating said selected service delivery model based on data collected subsequent to said activating;
wherein at least one of said evaluating, said selecting, said activating, and said re-evaluating is carried out by a computing device.

2. The method of claim 1, wherein said evaluating comprises evaluating the set of multiple service delivery models against the one or more metrics via service delivery model simulation.

3. The method of claim 2, wherein said simulation incorporates one or more aggregate service level agreement constraints.

4. The method of claim 2, wherein said simulation incorporates one or more queue management policies.

5. The method of claim 2, wherein said simulation incorporates varying service time estimates based on varying skill levels of individuals assigned to a service request.

6. The method of claim 1, wherein said one or more metrics comprises one or more of cost, quality of work, and utilization using a simulation based on inputs of arrival patterns, service time characteristics, resource skills, contractual service level agreements, shift schedules, and one or more policies.

7. The method of claim 1, comprising:
computing a distance metric that represents a measure of difficulty of shifting between two service delivery models.

8. The method of claim 1, comprising:
ranking said set of multiple service delivery models based on said evaluating.

9. The method of claim 8, wherein said selecting comprises selecting one service delivery model from the set of multiple service delivery models based on said ranking.

10. The method of claim 1, wherein said selecting comprises selecting one service delivery model from the set of multiple service delivery models based on relative importance of the one or more metrics.

11. The method of claim 1, wherein said activating comprises automatic activation.

12. The method of claim 1, wherein said activating comprises manual activation.

13. The method of claim 1, wherein each service delivery model in the set of multiple service delivery models comprises an instance of a service delivery meta-model including values associated with multiple elements and one or more relationships thereof.

14. An article of manufacture comprising a computer readable storage medium having computer readable instructions tangibly embodied thereon which, when implemented, cause a computer to carry out a plurality of method steps comprising:
evaluating a set of multiple delivery models against one or more metrics;
selecting one delivery model from the set of multiple delivery models based on said evaluating;
activating said selected one delivery model within a system; and
re-evaluating said selected service delivery model based on data collected subsequent to said activating.

15. The article of manufacture of claim 14, wherein the method steps comprise:
computing a distance metric that represents a measure of difficulty of shifting between two delivery models.

16. The article of manufacture of claim 14, wherein said evaluating comprises evaluating the set of multiple service delivery models against the one or more metrics via service delivery model simulation.

17. A system comprising:
a memory; and
at least one processor coupled to the memory and configured for:
evaluating a set of multiple delivery models against one or more metrics;
selecting one delivery model from the set of multiple delivery models based on said evaluating;
activating said selected one delivery model within a system; and
re-evaluating said selected service delivery model based on data collected subsequent to said activating.

18. A method comprising:
evaluating a set of multiple service delivery models against a set of multiple pre-defined metrics;
selecting a first service delivery model from the set of multiple service delivery models for implementation based on said evaluating;
re-evaluating said first service delivery model at a determined time interval based on data collected pertaining to one or more operational characteristics of the first service delivery model; and
changing implementation of the first service delivery model to implementation of a second service delivery model from the set of multiple service delivery models based a change in the one or more operational characteristics of the first service delivery model by a determined amount;
wherein at least one of said evaluating, said selecting, said re-evaluating, and said changing is carried out by a computing device.

19. The method of claim 18, wherein said one or more operational characteristics comprises workload, service time, service level agreement attainment, resource utilization, and/or quality of work.

20. The method of claim 18, wherein said change in the one or more operational characteristics of the first service delivery model by a determined amount comprises a change by a threshold percentage amount from a previous time interval.
